(19) United States
(12) Patent Application Publication
(10) Pub. No.: US 2026/0177721 A1
(43) Pub. Date: Jun. 25, 2026

(54) SUBSURFACE RESERVOIR CHARACTERIZATION FOR WELLS USING THREE-DIMENSIONAL RESISTIVITY MAPPING, THREE-DIMENSIONAL SONIC IMAGING AND WELLBORE IMAGES

(71) Applicant: Schlumberger Technology Corporation, Sugar Land, TX (US)

(72) Inventors: John Adam DONALD, Dubai (AE); Mauro VIANDANTE, Sugar Land, TX (US); Redha Hasan AL LAWATI, Muscat (OM); Maren Vebenstad EIDE, Muscat (OM)

(21) Appl. No.: 19/126,661

(22) PCT Filed: Nov. 3, 2023
(86) PCT No.: PCT/US2023/036778

§ 371 Date: May 2, 2025

Related U.S. Application Data
(60) Provisional application No. 63/382,361, filed on Nov. 4, 2022.

(51) Int. Cl. G01V 1/50

(52) U.S. Cl. CPC G01V 1/50

(57) ABSTRACT

Embodiments presented provide for performing reservoir characterization through analysis of data. Data related to three-dimensional resistivity mapping is combined with three-dimensional sonic imaging and other wellbore images to enable characterization of features of a geological field including the oil/water line. A computer readable storage can have non-transitory medium having data stored therein representing executable by a computer, software including instructions for performing one or more steps of disclosed methods.

### CROSS-REFERENCE TO RELATED APPLICATIONS

This application claims the benefit of U.S. Provisional Application No. 63/382,361, entitled “ SUBSURFACE RESERVOIR CHARACTERIZATION FOR WELLS USING THREE-DIMENSIONAL RESISTIVITY MAPPING, THREE-DIMENSIONAL SONIC IMAGING AND WELLBORE IMAGES,” filed Nov. 4, 2022, the disclosure of which is hereby incorporated herein by reference.

### FIELD OF THE DISCLOSURE

Aspects of the disclosure relate to mapping of geological stratum. More specifically, aspects of the disclosure relate to use of three-dimensional resistivity mapping, three-dimensional sonic imaging and wellbore images to properly characterize wells. For example, this can be used with any well, including high angle and/or horizontal.

### BACKGROUND

Well placement and real time evaluation of wells involve well-established methods that effectively ensures a consistent distance to the caprock and delineates sub-layers within the reservoir. Contrasts in deep resistivity measurements are interpreted as changes either hydrocarbon saturation or formation composition. In these methods, wellbore images show layer boundaries and fractures which intersect the wellbore. Sonic imaging in the same environment provides information about contrasts in acoustic impedance associated with geological features such as structural and stratigraphic boundaries, and the presence of natural fractures and faults.

There is a need to provide an apparatus and methods that are easier to operate than conventional apparatus and methods in order to characterize wells, including high angle and/or horizontal wells as well as other commonly encountered wells.

There is a further need to provide apparatus and methods that do not have the drawbacks of conventional apparatus, but rather use three-dimensional resistivity mapping in an efficient manner.

There is a still further need to reduce economic costs associated with operations and apparatus described above with conventional tools and provide proper characterization of geological stratum for wellbores.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, the method may comprise obtaining data from a resistivity mapping operation for a geological field and obtaining data from a sonic imaging of the geological field. The method may also comprise obtaining data related to wellbore images of a wellbore penetrating the geological field and processing the data from the resistivity mapping operation, the sonic imaging and the wellbore images. The method may also provide for obtaining at least one characterization of the geological field from the processing.

In another example embodiment, a computer readable storage non-transitory medium is disclosed having data stored therein representing executable by a computer, software including instructions performing steps of obtaining data from a resistivity mapping operation for a geological field. The steps may also comprise obtaining data from a sonic imaging of the geological field and obtaining data related to wellbore images of a wellbore penetrating the geological field. The steps may also comprise processing the data from the resistivity mapping operation, the sonic imaging and the wellbore images and obtaining at least one characterization of the geological field from the processing.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1A is an operational workflow for the LWD conveyed 3D resistivity mapping, borehole image (either LWD or WL) and the 3D sonic imaging

FIG. 1B is an example workflow to use borehole images, 3D sonic imaging and 3D resistivity mapping to interpret layers, fluids, and fractures.

FIG. 2 is a vertical cross section of resistivity mapping and acoustic reflectors. There is consistency between the acoustic reflector and the resistivity contrast at the top of the reservoir, however the bottom of the reservoir layer is detected by the acoustic reflector and thereby enabling the defining the saturation change within the same formation unit.

FIG. 3 is an identification of flow units whereby the vertical fractures interpretated from the sonic imaging are consistent with the lateral resistivity (associated to fluid saturation) changes determined from the resistivity mapping

FIG. 4 is a characterization of the layering and heterogeneity in the caprock using the reflectivity and resistivity contrast.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

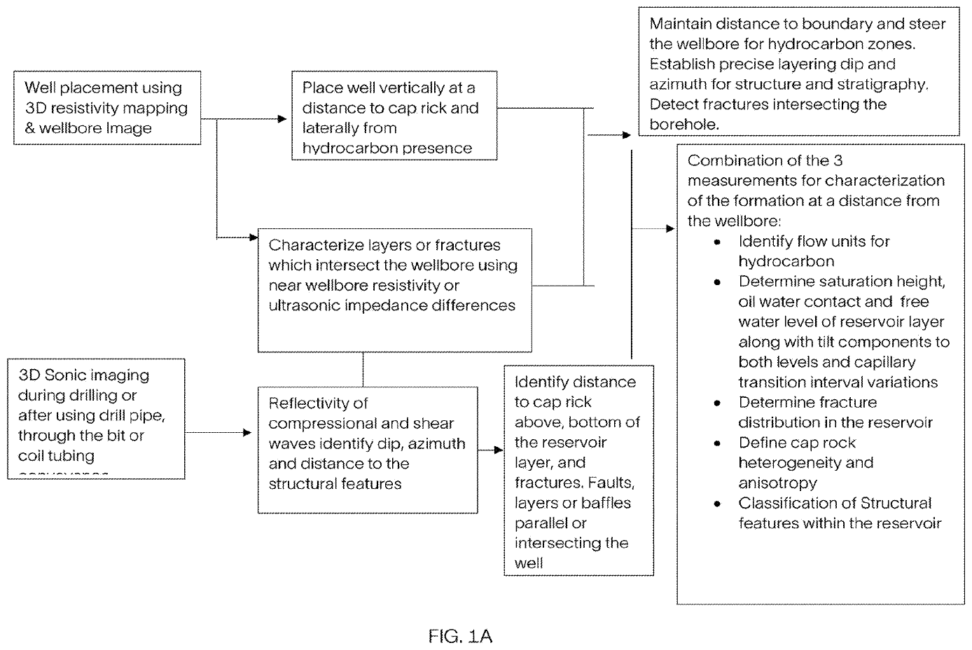

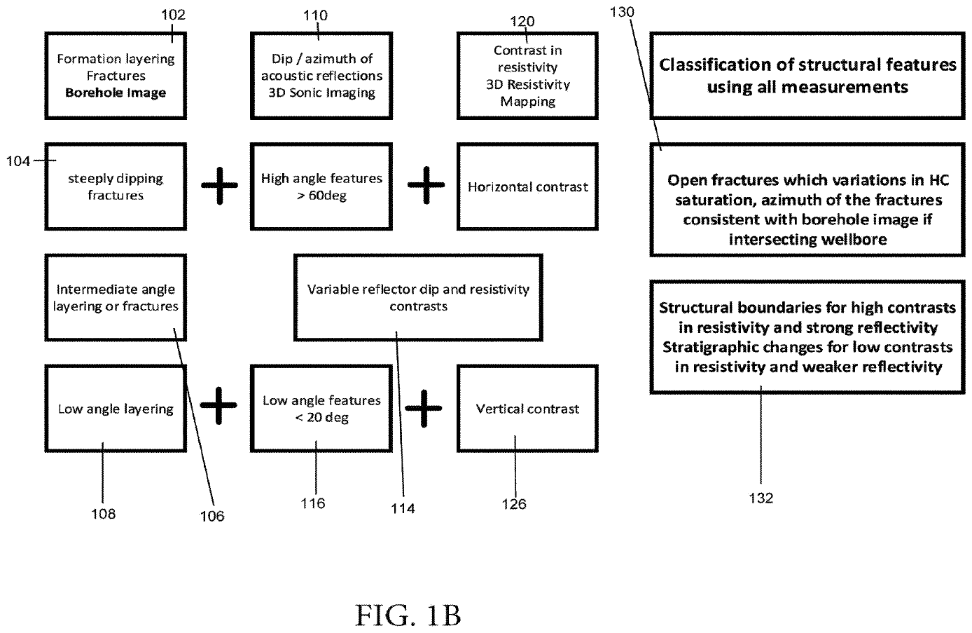

Aspects of the disclosure provide for a method for using a combination of data resources to accurately predict and classify a geological environment. Such geological environments are typically evaluated in conjunction with planned hydrocarbon recovery operations. FIG. 1A shows the operational workflow for the LWD conveyed 3D resistivity mapping, borehole image (either LWD or WL) and the 3D sonic imaging.

The integration of 3D resistivity mapping results, presented as 2D transverse resistivity inversions and 3D resistivity volumes, with 3D sonic imaging, presented as dip, azimuth, and distance of the reflector, provide an innovative approach that helped to unlock the full reservoir understanding. While interpreting 3D resistivity mapping results from a UDAR (Ultra-Deep Azimuthal Resistivity) tool, one of the main challenges is to understand and correlate the resistivity changes to formation boundaries or fluids changes within the volume of rock investigated. The 3D sonic imaging provides reflections caused by lithological or stratigraphic boundaries, and open natural fractures which may or may not intersect the borehole. By using the borehole images as a geological ground true at the wellbore, the classification of the resistivity or acoustic contrasts can be done jointly to provide a consistent interpretation. The workflow in FIG. 1A is followed to jointly interpret the features from the resistivity mapping, sonic imaging, and borehole images.

In a geological field characterized by a complex reservoir architecture (stratigraphy and fractures) with complex fluid relationships, aspects of the disclosure show how the first multi-physics integration of 3D Resistivity Mapping with 3D Sonic Imaging enables:
Unbiased integration based on independent measurements to characterize reservoir features (faults, fractures, lithology anisotropy, layering)
Validation interpretation in complex geological environments with structural features remotely detected away from the wellbore
Fluid distribution understanding at reservoir scale as a function of structural features (barrier/baffles and/or high/least resistance pathway) and stratigraphic elements.
Novel input for properties distribution and potential new dynamics reservoir understanding as opposed to exiting geostatistical methods to model properties and fluids flow history.

For the disclosure presented herein, there are three major discoveries that conventional apparatus and methods do not show and that are illustrated by multi-physics integration of 3D Resistivity Mapping with 3D Sonic Imaging. Each of these discoveries are disclosed and defined below. The disclosed apparatus and methods can be used for any well, including high angle wellbores, horizontal wells, and traditional wells, such as vertical wellbores or low angle wellbores. For the purposes of definition, a “high angle” wellbore is wellbore that is deviated from a vertical orientation greater than 45 degrees. A “horizontal” wellbore is a wellbore that is parallel, or essentially parallel, to a surface of the geological field.

### Determine Free Water Line

In one example embodiment of the disclosure, integration of 3D resistivity mapping with 3D sonic imaging allows for a determination of the free water line of a geological field. In consort with this, within a horizontal wellbore there is consistency of dip, azimuth, and distance to the cap rock for both the acoustic and resistivity measurements, however there is also a clear reflection from the bottom of the reservoir layer. The free water level within the reservoir layer can be determined as the resistivity profile defines the saturation changes until the bottom boundary. As described and defined herein, the free water level is the depth at which the pressure of the hydrocarbon phase is equal to water, and as the elevation increases the hydrocarbon pressure changes till its phase becomes mobile, which is the oil-water contact interface. From the three measurements, the spatial distribution of the contacts and its tilt with possibly transition zones changes can be mapped. In fact, the transition zones changes can be mapped for virgin reservoir unchanged fluid contacts caused by geological processes, altered fluid contacts caused by wellbore operations, injection, or production that result in imbibition of fluid and hence water breakthrough following pathways formed by fractures, bridge layers, surfaces, or other disruptions in the formation.

Conventional apparatus and methods fail to disclose the capability to determine the free water line, as defined above. Thus, receiving data related to three-dimensional resistivity mapping, three-dimensional sonic imaging and obtaining wellbore images, followed by processing of such data can reveal the free water line, something that previous processes/methods are unable to achieve.

### Delineate Flow Units

A second discovery and embodiment of the disclosure is the consistency between the steeply dipping or near vertical acoustic reflectors which are parallel to the well trajectory and the lateral changes in the resistivity profile on either side of the wellbore. This is interpreted as saturation changes laterally caused by the presence of near vertical fractures or compartmentalized flow units.

Conventional apparatus and methods fail to disclose the capability to delineate flow units, as defined above. Thus, receiving data related to three-dimensional resistivity mapping, three-dimensional sonic imaging and obtaining wellbore images, followed by processing of such data can delineate flow units, something that previous processes/methods are unable to achieve.

### Characterize Cap Rock Heterogeneity and Anisotropy

In another example embodiment of the disclosure, a third discovery is present. In this embodiment, aspects evaluated can determine the layering and heterogeneity within the cap rock layer. There are small resistivity contrasts and variable sub-horizontal reflectors that vary with strike and dip. Although sometimes the caprock is considered a large homogenous unit, the measurements highlight its heterogenous nature.

Conventional apparatus and methods fail to disclose the capability to delineate flow units, as defined above. Thus, receiving data related to three-dimensional resistivity mapping, three-dimensional sonic imaging and obtaining wellbore images, followed by processing of such data can characterize a cap rock heterogeneity and anisotropy, something that previous processes/methods are unable to achieve.

Referring to FIG. 1B, an example workflow, in conformance with one example embodiment of the disclosure is provided. In this embodiment, borehole images, 3D sonic imaging and 3D resistivity mapping are used to interpret layers, fluids, and fractures. Referring to FIG. 1B, the formation layering and borehole images are taken in 102. Three dimensional sonic images are taken at 110 and 3D resistivity mapping is taken at 120. For each column, different features from the data in 102, 110 and 120 are taken and combined with other features derived from other columns to derive a final characterization, in either open fractures which variations in hydrocarbon saturation azimuth of the fractures consistent with borehole image if intersecting the wellbore at 130 or structural boundaries for high contrasts in resistivity and strong reflectivity and stratigraphic changes for low contrasts in resistivity and weaker reflectivity at 132. As an example, steeply dipping fractures at 104 from the borehole images may be combined with data from high angle features (greater than 60 degrees) from 3D sonic imaging 110 and horizontal contrast 122 from 3D resistivity mapping 120 to arrive at the results in 130. In another example embodiment, low angle layering 108 may be combined with low angle features (less than 20 degrees) 116 from 3D sonic imaging 110 and vertical contrast 126 with 3D resistivity mapping 120 to arrive at results in 132. In another example embodiment, intermediate angle layering or fractures 106 from borehole images may be combined with variable reflector dip and resistivity contrasts 114 from either 3D sonic imaging 110 or 3D resistivity mapping 120 to arrive at results in 130 and/or 132.

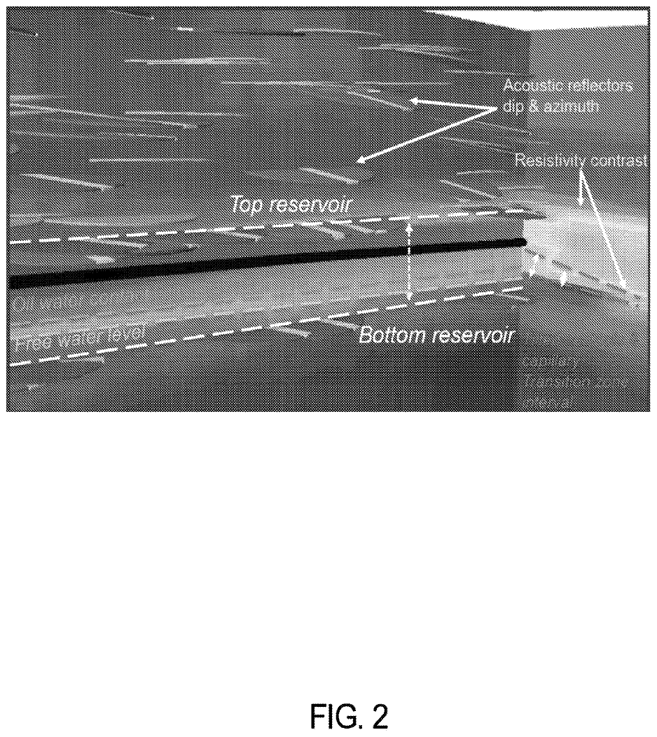

FIG. 2 is a vertical cross section of resistivity mapping and acoustic reflectors. There is consistency between the acoustic reflector and the resistivity contrast at the top of the reservoir, however the bottom of the reservoir layer is detected by the acoustic reflector and thereby enabling the defining the saturation change within the same formation unit.

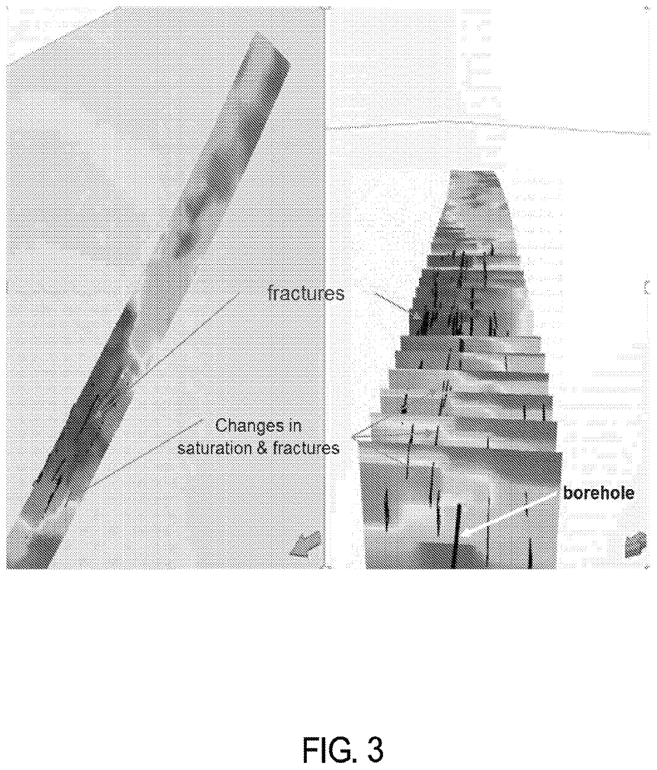

FIG. 3 is an identification of flow units whereby the vertical fractures interpretated from the sonic imaging are consistent with the lateral resistivity (associated to fluid saturation) changes determined from the resistivity mapping

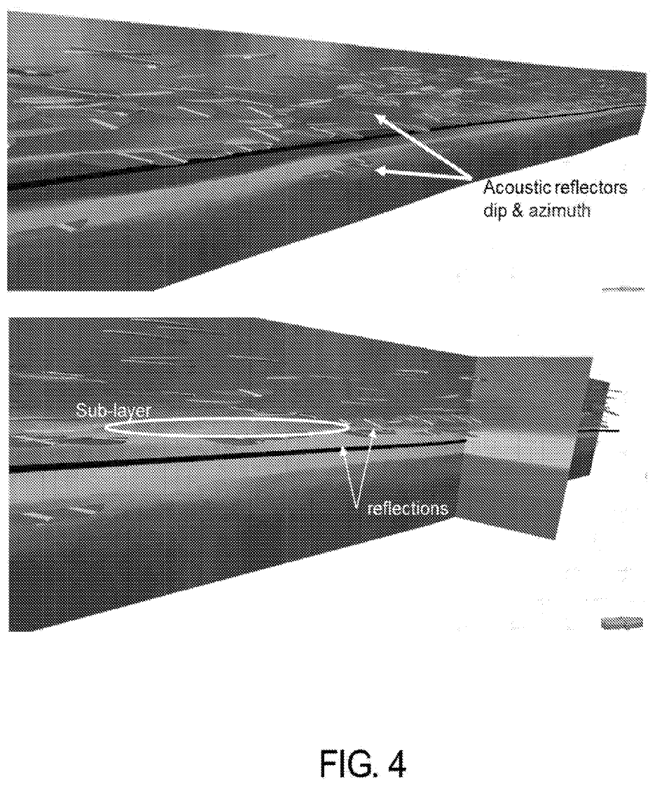

FIG. 4 is a characterization of the layering and heterogeneity in the caprock using the reflectivity and resistivity contrast.

Next, different embodiments of the disclosure are described, in conformance with embodiments discussed. In one example embodiment, a method is disclosed. The method may comprise obtaining data from a resistivity mapping operation for a geological field and obtaining data from a sonic imaging of the geological field. The method may also comprise obtaining data related to wellbore images of a wellbore penetrating the geological field and processing the data from the resistivity mapping operation, the sonic imaging and the wellbore images. The method may also provide for obtaining at least one characterization of the geological field from the processing.

In another example embodiment, the method may be performed wherein the sonic imaging of the geological field is a three-dimensional sonic imaging.

In another example embodiment, the method may be performed wherein the resistivity mapping operation for the geological field is a three-dimensional resistivity mapping operation.

In another example embodiment, the method may be performed wherein the wellbore is a high angle wellbore.

In another example embodiment, the method may be performed wherein the wellbore is a horizontal wellbore.

In another example embodiment, the method may be performed wherein the at least one characterization is a free water line for the geological field.

In another example embodiment, the method may be performed wherein the at least one characterization is flow units for the geological field.

In another example embodiment, the method may be performed wherein the at least one characterization is heterogeneity of a cap rock layer.

In another example embodiment, the method may be performed wherein the at least one characterization is an anisotropy of a cap rock layer.

In another example embodiment, the method may be performed wherein the at least one characterization is a saturation height of the geological field.

In another example embodiment, the method may be performed wherein the at least one characterization is a fracture distribution of the geological field.

In another example embodiment, a computer readable storage non-transitory medium is disclosed having data stored therein representing executable by a computer, software including instructions performing steps of obtaining data from a resistivity mapping operation for a geological field. The steps may also comprise obtaining data from a sonic imaging of the geological field and obtaining data related to wellbore images of a wellbore penetrating the geological field. The steps may also comprise processing the data from the resistivity mapping operation, the sonic imaging and the wellbore images and obtaining at least one characterization of the geological field from the processing.

In another example embodiment, the medium may be configured wherein the sonic imaging of the geological field is a three-dimensional sonic imaging.

In another example embodiment, the medium may be configured wherein the resistivity mapping operation for the geological field is a three-dimensional resistivity mapping operation.

In another example embodiment, the medium may be configured wherein the wellbore is a high angle wellbore.

In another example embodiment, the medium may be configured wherein the wellbore is a horizontal wellbore.

In another example embodiment, the medium may be configured wherein the at least one characterization is a free water line for the geological field.

In another example embodiment, the medium may be configured wherein the at least one characterization is flow units for the geological field.

In another example embodiment, the medium may be configured wherein the at least one characterization is heterogeneity of a cap rock layer.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method, comprising:
obtaining data from a resistivity mapping operation for a geological field;
obtaining data from a sonic imaging of the geological field;
obtaining data related to wellbore images of a wellbore penetrating the geological field;
processing the data from the resistivity mapping operation, the sonic imaging and the wellbore images; and
obtaining at least one characterization of the geological field from the processing.

2. The method according to claim 1, wherein the sonic imaging of the geological field is a three-dimensional sonic imaging.

3. The method according to claim 1, wherein the resistivity mapping operation for the geological field is a three-dimensional resistivity mapping operation.

4. The method according to claim 1, wherein the wellbore is a high angle wellbore.

5. The method according to claim 1, wherein the wellbore is a horizontal wellbore.

6. The method according to claim 1, wherein the at least one characterization is a free water line for the geological field.

7. The method according to claim 1, wherein the at least one characterization is flow units for the geological field.

8. The method according to claim 1, wherein the at least one characterization is heterogeneity of a cap rock layer.

9. The method according to claim 1, wherein the at least one characterization is an anisotropy of a cap rock layer.

10. The method according to claim 1, wherein the at least one characterization is a saturation height of the geological field.

11. The method according to claim 1, wherein the at least one characterization is a fracture distribution of the geological field.

12. A computer readable storage non-transitory medium having data stored therein representing executable by a computer, software including instructions performing steps of:
obtaining data from a resistivity mapping operation for a geological field;
obtaining data from a sonic imaging of the geological field;
obtaining data related to wellbore images of a wellbore penetrating the geological field;
processing the data from the resistivity mapping operation, the sonic imaging and the wellbore images; and
obtaining at least one characterization of the geological field from the processing.

13. The medium according to claim 12, wherein the sonic imaging of the geological field is a three-dimensional sonic imaging.

14. The medium according to claim 12, wherein the resistivity mapping operation for the geological field is a three-dimensional resistivity mapping operation.

15. The medium according to claim 12, wherein the wellbore is a high angle wellbore.

16. The medium according to claim 12, wherein the wellbore is a horizontal wellbore.

17. The medium according to claim 12, wherein the at least one characterization is a free water line for the geological field.

18. The medium according to claim 12, wherein the at least one characterization is flow units for the geological field.

19. The medium according to claim 12, wherein the at least one characterization is heterogeneity of a cap rock layer.
